(19) United States
(12) Patent Application Publication
(10) Pub. No.: US 2026/0205517 A1
(43) Pub. Date: Jul. 16, 2026

(54) TRACKING INFORMATION ALIGNMENT METHOD, TRACKING SYSTEM AND COMPUTER-READABLE STORAGE MEDIUM

(71) Applicant: HTC Corporation, Taoyuan City (TW)

(72) Inventor: Shang-I Wong, Taoyuan City (TW)

(73) Assignee: HTC Corporation, Taoyuan City (TW)

(21) Appl. No.: 19/025,945

(22) Filed: Jan. 16, 2025

(51) Int. Cl. H04L 67/131; G06F 3/01; G06K 7/14; G06T 7/62; G06T 7/73; G06T 19/20

(52) U.S. Cl. CPC H04L 67/131; G06F 3/011; G06K 7/1404; G06T 7/62; G06T 7/73; G06T 19/20; G06T 2219/2004

(57) ABSTRACT

Embodiments of the disclosure provide a tracking information alignment method, a tracking system and a computer-readable storage medium. The method includes: displaying, by a first tracking device, an information pattern through an outward display; capturing, by a second tracking device, the information pattern, and accordingly determining a reference relative pose between the first tracking device and the second tracking device, and obtaining device information of the first tracking device; after the first tracking device and the second tracking device establish a connection based on the device information, sending, by the first tracking device, a first device pose of the first tracking device to the second tracking device through the connection; and determining, by the second tracking device, a coordinate conversion relationship based on the reference relative pose and the received first device pose, and accordingly converting the received first device pose into a first reference device pose.

### BACKGROUND

### Technical Field

The disclosure relates to a tracking mechanism, and particularly relates to a tracking information alignment method, a tracking system and a computer-readable storage medium.

### Description of Related Art

Multi-player virtual reality (VR) service is a technology platform that allows multiple users to interact simultaneously in a virtual environment. It combines virtual reality technology, network connections and multi-user collaboration functions to create immersive social, gaming or work experiences. Users may interact in real-time in the 3D environment through head-mounted displays and related accessories (such as handheld controllers) and simulate real-world sensory experiences.

In order for the above applications to proceed smoothly, each player's head-mounted display may first need to obtain the device pose tracked by other tracking devices (such as another player's head-mounted display) to successfully present the corresponding information (such as corresponding to other players' avatars) in the provided visual content.

In some applications, before a primary device obtains the device pose of other tracking devices, the primary device may first need to establish a connection with other tracking devices, and then perform a series of processes and lengthy actions such as user active input to complete operations such as establishing connections, associations between physical devices, and position correction.

Therefore, how to design a technical solution that may improve the above method is an important issue for those skilled in the art.

In view of this, the disclosure provides a tracking information alignment method, a tracking system and a computer-readable storage medium, which may be used to solve the above technical problems.

An embodiment of the disclosure provides a tracking information alignment method, which includes: displaying, by a first tracking device, an information pattern through an outward display, where the information pattern indicates device information of the first tracking device; capturing, by a second tracking device, the information pattern, and accordingly determining a reference relative pose between the first tracking device and the second tracking device, and obtaining the device information of the first tracking device; after the first tracking device and the second tracking device establish a connection based on the device information, sending, by the first tracking device, a first device pose of the first tracking device to the second tracking device through the connection, where the first device pose is characterized based on a first coordinate system used by the first tracking device; and determining, by the second tracking device, a coordinate conversion relationship based on the reference relative pose and the received first device pose, and accordingly converting the received first device pose into a first reference device pose, where the first reference device pose is characterized based on a second coordinate system used by the second tracking device.

An embodiment of the disclosure provides a tracking system, including a first tracking device and a second tracking device. The first tracking device is configured to display an information pattern through an outward display, where the information pattern indicates device information of the first tracking device. The second tracking device is configured to capture the information pattern and accordingly determine a reference relative pose between the first tracking device and the second tracking device, and obtain the device information of the first tracking device. After the first tracking device and the second tracking device establish a connection based on the device information, the first tracking device sends a first device pose of the first tracking device to the second tracking device through the connection, where the first device pose is characterized based on a first coordinate system used by the first tracking device. The second tracking device determines a coordinate conversion relationship based on the reference relative pose and the received first device pose, and accordingly converts the received first device pose into a first reference device pose, where the first reference device pose is characterized based on a second coordinate system used by the second tracking device.

An embodiment of the disclosure provides a non-transitory computer-readable storage medium. The non-transitory computer-readable storage medium records an executable computer program, and the executable computer program is loaded by a first tracking device and a second tracking device to perform the following steps: displaying, by the first tracking device, an information pattern through an outward display, where the information pattern indicates device information of the first tracking device; capturing, by the second tracking device, the information pattern, and accordingly determining a reference relative pose between the first tracking device and the second tracking device, and obtaining the device information of the first tracking device; after the first tracking device and the second tracking device establish a connection based on the device information, sending, by the first tracking device, a first device pose of the first tracking device to the second tracking device through the connection, where the first device pose is characterized based on a first coordinate system used by the first tracking device; and determining, by the second tracking device, a coordinate conversion relationship based on the reference relative pose and the received first device pose, and accordingly converting the received first device pose into a first reference device pose, where the first reference device pose is characterized based on a second coordinate system used by the second tracking device.

### BRIEF DESCRIPTION OF THE DRAWINGS

FIG. 1 is a schematic diagram of a tracking system according to an embodiment of the disclosure.

FIG. 2 is a flow chart of a tracking information alignment method according to an embodiment of the disclosure.

FIGS. 3A to FIG. 3G are schematic diagrams of application scenarios according to an embodiment of the disclosure.

Referring to FIG. 1, FIG. 1 is a schematic diagram of a tracking system according to an embodiment of the disclosure. In FIG. 1, a tracking system 100 includes a first tracking device 102 and a second tracking device 104. In different embodiments, the first tracking device 102 and the second tracking device 104 may be implemented as devices capable of performing various tracking functions (such as inside-out tracking and/or outside-in tracking).

In some embodiments, the first tracking device 102 may be disposed with a tracking camera, which may be used to capture images of the environment where the first tracking device 102 is located, and accordingly perform tracking functions such as simultaneous localization and mapping (SLAM) to establish map information (such as a SLAM map) of the environment. In an embodiment, the first tracking device 102 may accordingly determine its own device pose in the environment after determining the map information (which may, for example, be presented in the form of six degrees of freedom), but the disclosure is not limited thereto.

In some embodiments, the tracking camera of the first tracking device 102 may be used to photograph the object to be tracked (such as the human body, a handheld controller and/or various wearable devices) to obtain an image of the object, and the pose of the object to be tracked (such as the pose of each joint point on the human body, the pose of a handheld controller, and/or the pose of various wearable devices) may be determined through relevant pose recognition algorithms, but the disclosure is not limited thereto.

In some embodiments, the first tracking device 102 is, for example, a head-mounted display (HMD) that may be used to provide/display visual content of a reality service to a wearer. The reality services include, for example, augmented reality (AR), virtual reality (VR), mixed reality (MR) and/or extended reality (XR), but the disclosure is not limited thereto.

In FIG. 1, the first tracking device 102 may include an outward display 112, where the outward display 112 may be used, for example, to provide a visual information display function to external users or devices.

In an embodiment of the disclosure, the second tracking device 104 may be implemented using the same or similar implementation method as the first tracking device 102. For ease of understanding, it will be assumed below that the first tracking device 102 and the second tracking device 104 are HMDs worn by corresponding users, but the disclosure is not limited thereto.

In embodiments where the first tracking device 102 is assumed to be an HMD, the first tracking device 102 may include a near-eye display that may be used to provide/display relevant visual content to a user wearing the first tracking device 102. In an embodiment, the first tracking device 102 may display visual content to the user using a near-eye display and at the same time display required information on the outward display 112 for external devices (such as the second tracking device 104) and/or external users (such as another user) to view, but the disclosure is not limited thereto.

In some embodiments, the visual content, for example, corresponds to a virtual world (such as a VR world) of a reality service provided by an HMD, but the disclosure is not limited thereto.

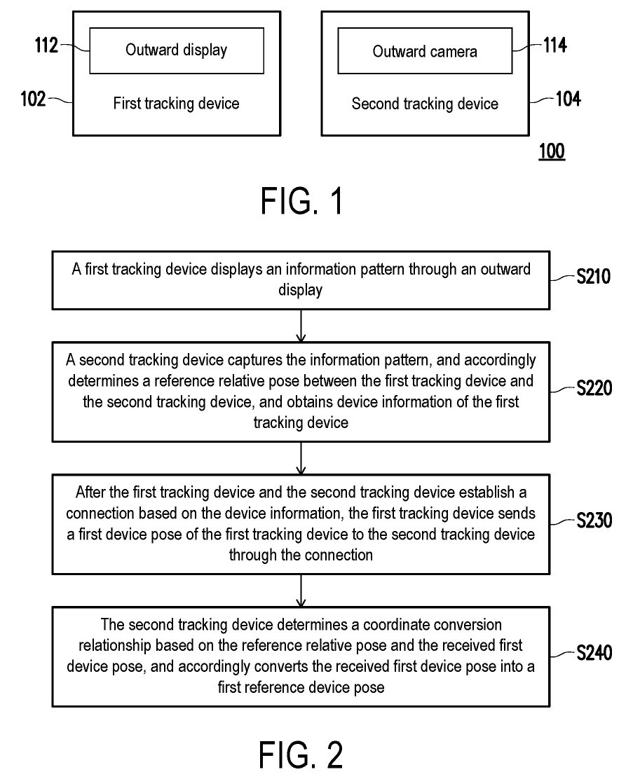

Referring to FIG. 2, FIG. 2 is a flow chart of a tracking information alignment method according to an embodiment of the disclosure. The method of the embodiment may be executed by the tracking system 100 depicted in FIG. 1. The details of each step depicted in FIG. 2 will be described below with reference to the components shown in FIG. 1.

First, in step S210, the first tracking device 102 displays an information pattern through the outward display 112, where the information pattern indicates device information of the first tracking device 102.

In different embodiments, the information pattern is, for example, a QR code, an Aruco code, a barcode, text, and/or other patterns that may carry the required information, but the disclosure is not limited thereto. In an embodiment, the information pattern is dynamically displayed instead of being static like printed matter.

In some embodiments, the way the first tracking device 102 dynamically displays the information pattern may be performed based on different criteria, such as the user's choices regarding the device ID, supported connection protocols, and display formats (such as QR code, barcode, text, etc.).

In some embodiments, the device information of the first tracking device 102 may include, for example, identification information and supported connection protocols. In an embodiment, the identification information is, for example, the identification information of the user of the first tracking device 102 (such as the user's name, account number, code, device ID, Bluetooth MAC address, Wi-Fi SSID, etc.). In addition, the connection protocols supported by the first tracking device 102 may include, for example, communication protocols that may be used to establish a connection with the first tracking device 102, such as Bluetooth, Wi-Fi, etc., but the disclosure is not limited thereto.

In step S220, the second tracking device 104 captures the information pattern, and accordingly determines a reference relative pose between the first tracking device 102 and the second tracking device 104, and obtains the device information of the first tracking device 102.

In an embodiment where the second tracking device 104 is assumed to be an HMD, the second tracking device 104 may, for example, capture images of the scene in front of and/or near the second tracking device 104 through an outward camera 114 (such as a front-facing camera).

In an embodiment, when the information pattern displayed on the outward display 112 appears within the imaging range of the outward camera 114 of the second tracking device 104, the second tracking device 104 may capture an image including the information pattern. Afterwards, the second tracking device 104 may parse the information carried by the information pattern (such as the device information of the first tracking device 102) through pattern analysis technology corresponding to the information pattern.

In an embodiment, the information carried by the information pattern may also include display size information of the information pattern, where the display size information is, for example, the size of the information pattern displayed on the outward display 112. For example, if the outward display 112 displays an information pattern implemented as a QR code with MxN pixels (M and N are positive integers), the display size information may indicate MxN, but the disclosure is not limited thereto.

In an embodiment, after the second tracking device 104 captures an image including the information pattern with the outward camera 114, the second tracking device 104 may determine the pattern size of the information pattern in the image. Thereafter, the second tracking device 104 may determine the reference relative pose between the first tracking device 102 and the second tracking device 104 based on the proportional relationship between the display size information of the information pattern and the pattern size of the information pattern in the image.

For example, the second tracking device 104 may measure the pattern size of the information pattern on the image plane from the captured image, and combine it with the internal parameters of the outward camera 114 (such as the focal length and the pixel size of the photosensitive element) to estimate the proportional relationship between the actual size of the information pattern and its projected size in the image. According to this proportional relationship, the second tracking device 104 may obtain the distance from the outward camera 114 and/or the second tracking device 104 to the outward display 112 by applying the perspective projection formula. Also, the second tracking device 104 may further analyze the deformation of the information pattern in the image, such as the edge perspective change of the rectangular pattern, and combine it with the pose parameters of the outward camera 114 to calculate the relative translation and rotation, thereby determining the direction of the first tracking device 102 relative to the second tracking device 104. Thereby, the reference relative pose between the first tracking device 102 and the second tracking device 104 may be determined accordingly, but the disclosure is not limited thereto.

In another embodiment, the second tracking device 104 may be disposed with a depth camera, and after the depth camera obtains a depth map capturing the information pattern, the second tracking device 104 may determine the reference relative pose between the first tracking device 102 and the second tracking device 104 based on the depth map. Relevant methods may be found in the associated prior art documents, and the details are not repeated herein.

In an embodiment where the second tracking device 104 is capable of SLAM technology, the second tracking device 104 may also determine the reference relative pose between the first tracking device 102 and the second tracking device 104 based on the SLAM concept when the relevant tracking camera captures an image of the information pattern. For example, the second tracking device 104 may find feature points corresponding to the information pattern from the images captured by the tracking camera, and then determine the reference relative pose between the first tracking device 102 and the second tracking device 104 based on the relative position/pose between these feature points and the second tracking device 104. For relevant means, please refer to the literature related to SLAM, and the details are not repeated herein.

In the embodiment of the disclosure, the reference relative pose is, for example, the device pose of the first tracking device 102 relative to the second tracking device 104, but the disclosure is not limited thereto.

In different embodiments, after step S220, the first tracking device 102 and the second tracking device 104 may establish a connection through any known connection establishment means. For example, if the information pattern indicates that the connection protocol supported by the first tracking device 102 is Bluetooth and/or Wi-Fi, the first tracking device 102 and the second tracking device 104 may, for example, accordingly establish a Bluetooth connection and/or Wi-Fi connection based on the associated address (e.g., BT MAC addresses), Wi-Fi SSID, and passwords, but the disclosure is not limited thereto.

In step S230, after the first tracking device 102 and the second tracking device 104 establish a connection based on the device information, the first tracking device 102 sends the first device pose of the first tracking device 102 to the second tracking device 104 through the connection.

In an embodiment of the disclosure, the first device pose is characterized, for example, based on the first coordinate system used by the first tracking device 102. The first coordinate system is, for example, the coordinate system (such as the world coordinate system) used by the first tracking device 102 when tracking its own first device pose.

In an embodiment, assuming that the first tracking device 102 tracks its own first device pose through SLAM, the origin of the first coordinate system may be, for example, the position when the first tracking device 102 starts executing SLAM, but the disclosure is not limited thereto.

However, since the coordinate system used by the second tracking device 104 (hereinafter referred to as a second coordinate system) may be inconsistent with the first coordinate system, if the received first device pose is directly used to determine the position of the first tracking device 102 relative to the second tracking device 104, it may not be accurate.

Therefore, in step S240, the second tracking device 104 determines the coordinate conversion relationship based on the reference relative pose and the received first device pose, and accordingly converts the received first device pose into a first reference device pose. The first reference device pose is characterized based on the second coordinate system used by the second tracking device 104.

In an embodiment, assume that the reference relative pose is obtained when there is a specific relative position between the first tracking device 102 and the second tracking device 104, the first device pose may, for example, be obtained when the specific relative position is also present between the first tracking device 102 and the second tracking device 104.

In this case, the second tracking device 104 may know what device pose the first tracking device 102 is relative to the second tracking device 104 when the first device pose exhibits a certain state/value combination (i.e., the reference relative pose).

Based on this, the second tracking device 104 may, for example, determine the coordinate conversion relationship by subtracting the reference relative pose from the first device pose. In the embodiment, the coordinate conversion relationship may be understood as being used to represent the conversion relationship from the first coordinate system to the second coordinate system, but the disclosure is not limited thereto.

For example, assume that the reference relative pose is characterized by a six-degree-of-freedom form of (x1, y1, z1, α1, β1, γ1), and the first device pose is characterized by a six-degree-of-freedom form of (x2, y2, z2, α2, β1, γ2), then, for example, the second tracking device 104 may determine that the coordinate conversion relationship is (x2-x1, y2-y1, z2-z1, α2-α1, β2-β1, γ2-γ1), but the disclosure is not limited thereto.

Thereby, the second tracking device 104 may correctly determine which position (i.e., the first reference device pose) in the second coordinate system substantially corresponds to first device pose provided by the first tracking device 102 based on the coordinate conversion relationship.

Taking the first device pose as an example, the second tracking device 104 may convert the first device pose into the first reference device pose by subtracting the coordinate conversion relationship from the first device pose.

In some embodiments, assuming that the second tracking device 104 subsequently receives the updated first device pose reported by the first tracking device 102, the second tracking device 104 may also determine the updated first reference device pose based on the above description, but the disclosure is not limited thereto.

In an embodiment where the second tracking device 104 is assumed to be used to display visual content corresponding to a virtual world (for example, a VR world), the second tracking device 104 may render a first avatar corresponding to the first tracking device 102 based on the first reference device pose. The second tracking device 104 may then display the rendered first avatar in the visual content.

In an embodiment, the virtual world may include a second avatar corresponding to the second tracking device 104, and a first relative position between the first avatar and the second avatar corresponds to a second relative position between the first tracking device and the second tracking device.

For example, assuming that the first tracking device 102 is three meters in front and left of the second tracking device 104, the first avatar in the virtual world will also be located three meters in front and left of the second avatar, but the disclosure is not limited thereto.

In an embodiment, if the first tracking device 102 moves along with the movement of the corresponding user, the first tracking device 102 may provide an updated first device pose to the second tracking device 104. In this case, the second tracking device 104 may determine the updated first reference device pose according to the previous description, and may update the position of the first avatar in the virtual world based on the updated first reference device pose.

For example, if the updated first reference device pose shows that the first tracking device 102 has moved two meters in front of the second tracking device 104, the second tracking device 104 will accordingly render the first avatar in the virtual world two meters in front of the second avatar, but the disclosure is not limited thereto.

In an embodiment, the second tracking device 104 may provide the determined coordinate conversion relationship to the first tracking device 102. In this case, the first tracking device 102 may correspondingly derive another conversion relationship from the second coordinate system to the first coordinate system based on the coordinate conversion relationship provided by the second tracking device 104.

In this case, the second tracking device 104 may also send its tracked pose (hereinafter referred to as a second device pose) to the first tracking device 102 through a connection. Correspondingly, the first tracking device 102 may also convert the received second device pose into a second reference device pose based on the above principles. The second reference device pose is characterized based on the first coordinate system used by the first tracking device 102, but the disclosure is not limited thereto.

Based on this, the first tracking device 102 may also render the second avatar corresponding to the second tracking device 104 based on the second reference device pose, but the disclosure is not limited thereto.

It should be understood that although the above embodiments only illustrate the interaction between the first tracking device 102 and the second tracking device 104, this is only used as an example and is not intended to limit the possible implementations of the disclosure.

It can be seen from the above that the technical solution of the embodiment of the disclosure may align the tracking information between the first tracking device and the second tracking device in a more convenient and concise manner, thereby improving the user experience.

In other embodiments, the tracking system 100 may also include other tracking devices, and the first tracking device 102 and/or the second tracking device 104 may determine the corresponding coordinate conversion relationship according to the method described in the previous embodiments, and the details are not repeated herein.

In a scenario where the tracking system 100 further includes other tracking devices (such as a multi-player scenario), the first tracking device 102 may simultaneously send the identification information of the first tracking device 102 to the second tracking device 104 when providing the (updated) first device pose. This may avoid the situation where the second tracking device 104 confuses the information provided by the first tracking device 102 with the information provided by other tracking devices.

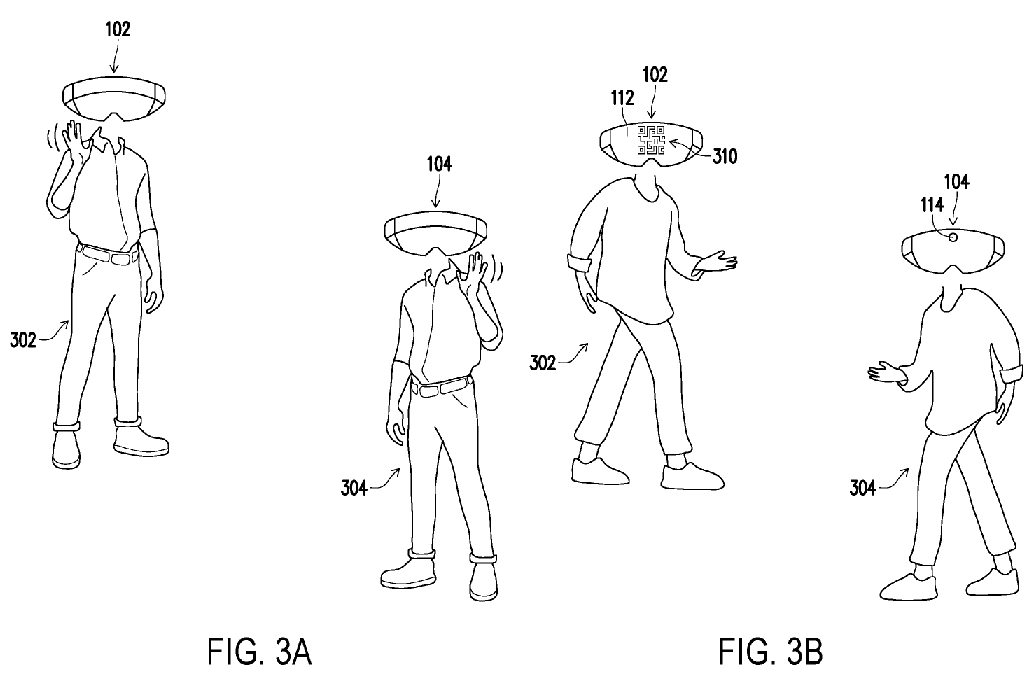

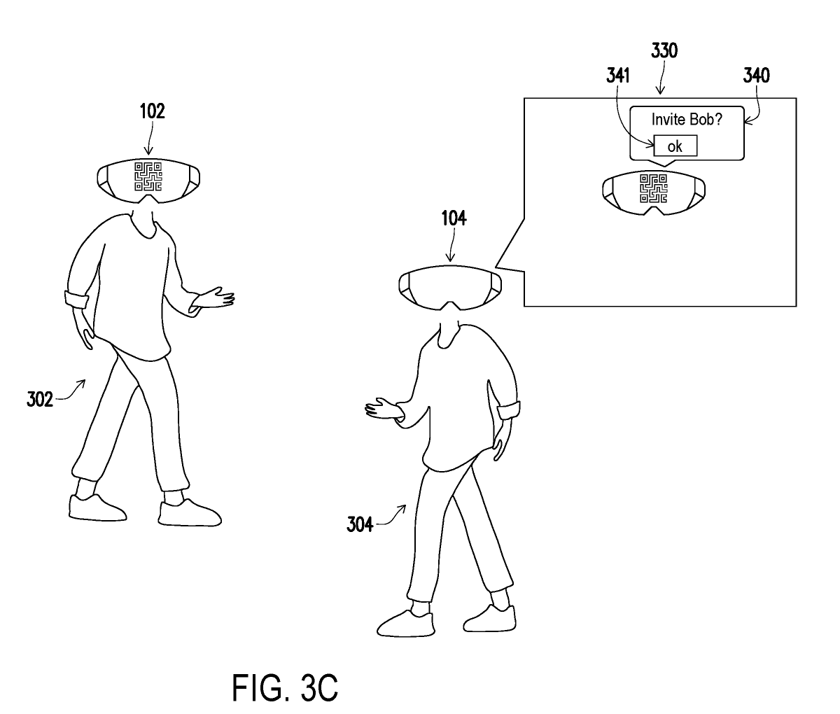

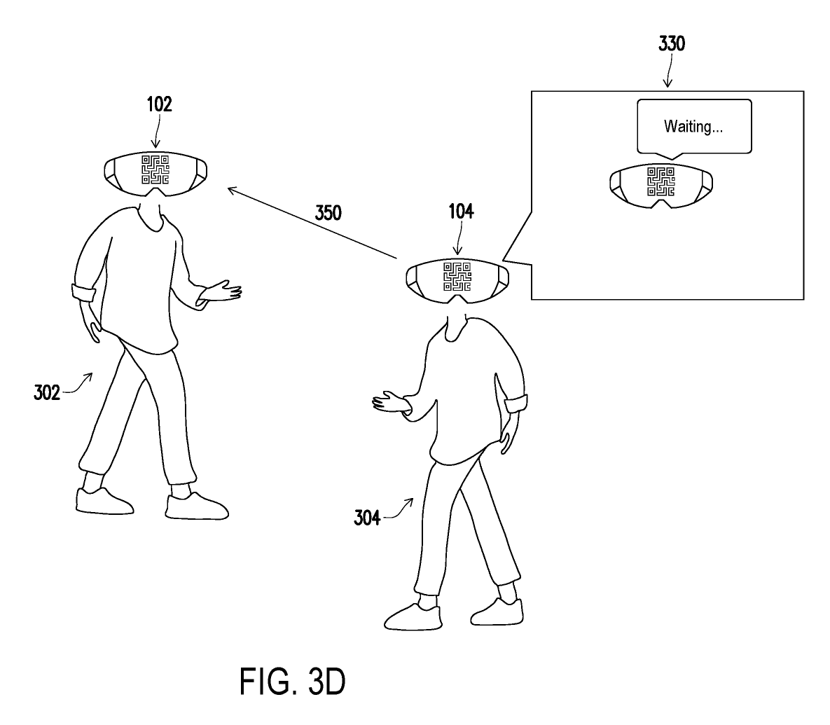

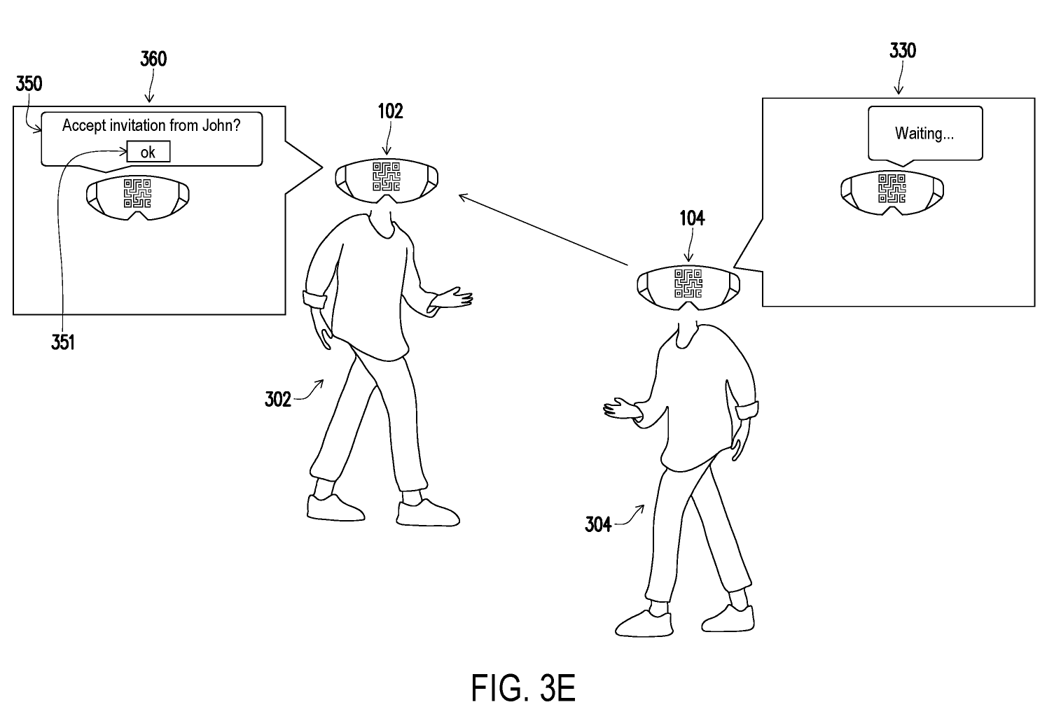

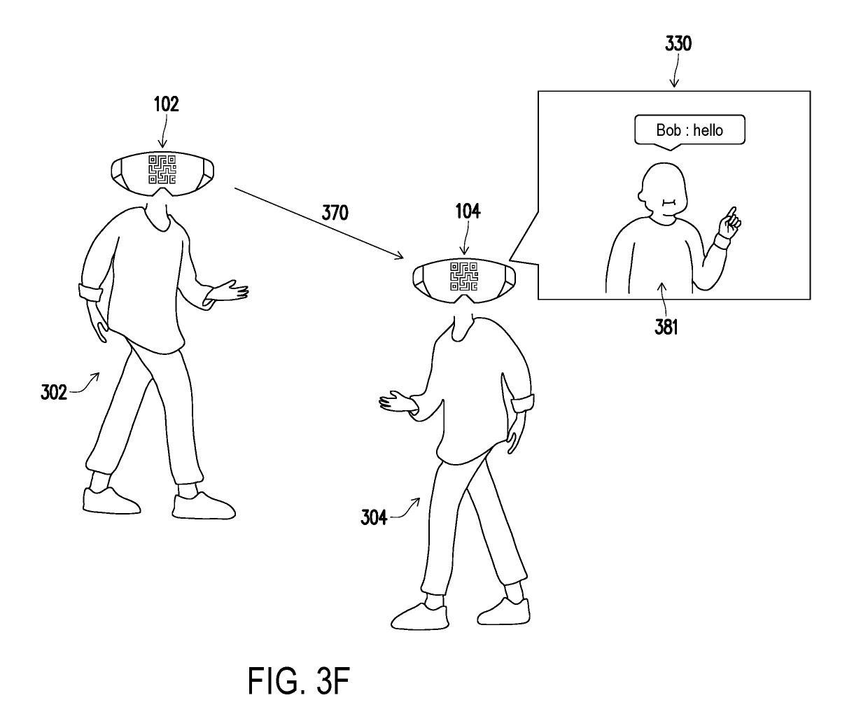

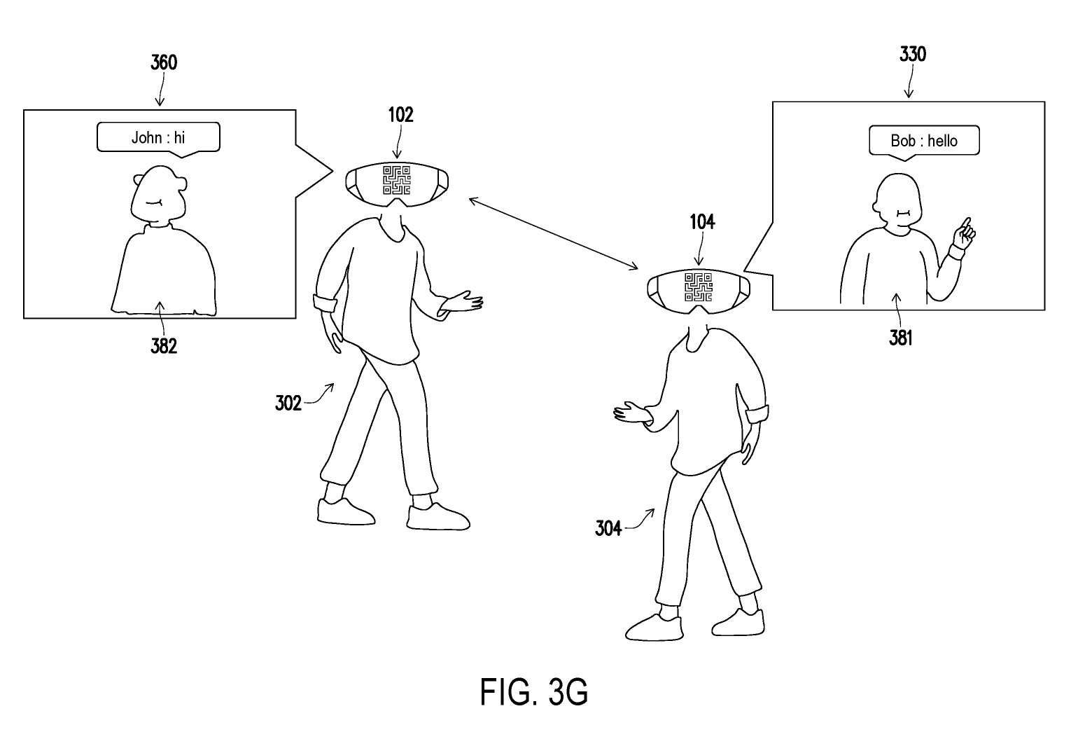

Referring to FIGS. 3A to FIG. 3G, FIGS. 3A to 3G are schematic diagrams of application scenarios according to an embodiment of the disclosure.

In the scenario of FIG. 3A, assume that a user 302 (whose name is, for example, "Bob") and a user 304 (whose name is, for example, "John") encounter each other while respectively wearing the first tracking device 102 and the second tracking device 104 (each of which is, for example, a HMD). For example, the user 304 may maintain a server with a certain function (such as a game server, a chat room server, etc.).

In the scenario of FIG. 3B, assuming that the user 302 wants to join the above-mentioned server, the user 302 may, for example, trigger a corresponding function to control the first tracking device 102 to display an information pattern 310 (such as a QR code) through the outward display 112. In this case, the second tracking device 104 may, for example, capture an image including the information pattern 310 through the outward camera 114. Afterwards, the second tracking device 104 may determine the reference relative pose between the first tracking device 102 and the second tracking device 104 and the device information of the first tracking device 102 according to the description of the previous embodiment.

In the scenario of FIG. 3C, the second tracking device 104 may display an invitation confirmation message 340 associated with the first tracking device 102 in a provided visual content 330 (for example, VR content for the user 304 to view) based on the device information (for example, the name Bob of the user 302) of the first tracking device 102.

In FIG. 3C, the invitation confirmation message 340 may, for example, ask the user 304 whether to invite the user 302 to join the server, and may include a confirmation button 341 for the user 304 to confirm.

In response to determining that the invitation confirmation message 340 is triggered (for example, the confirmation button 341 is triggered), the second tracking device 104 may establish a connection with the first tracking device 102. For example, the second tracking device 104 may establish a corresponding connection with the first tracking device 102 according to the connection protocol supported by the first tracking device 102, but the disclosure is not limited thereto.

Then, in the scenario of FIG. 3D, the second tracking device 104 may send an invitation message 350 to the first tracking device 102 through the connection, where the invitation message 350 may be used to invite the first tracking device 102 to join the above-mentioned server.

In the embodiment, the second tracking device 104 may display the corresponding waiting message in the provided visual content 330, but the disclosure is not limited thereto.

In the scenario of FIG. 3E, the first tracking device 102 may, for example, display the invitation message 350 in a provided visual content 360 (for example, VR content). The invitation message 350 may, for example, ask the user 302 whether he agrees to join the server maintained by the user 304, and may include a confirmation button 351 for the user 302 to confirm.

In the scenario of FIG. 3F, the first tracking device 102 may send a confirmation message 370 to the second tracking device 104 when the invitation message 350 is confirmed (for example, the confirmation button 351 is triggered). Accordingly, the second tracking device 104 may respond to the confirmation message 370 by adding the first tracking device 102 to the server.

In this case, the second tracking device 104 may, for example, display a first avatar 381 corresponding to the user 302 in the provided visual content 330.

In the embodiment, the rendering position of the first avatar 381 is, for example, determined based on the method described in the previous embodiment. For example, the virtual world presented by the visual content 330 may also include a second avatar corresponding to the user 304, and the relative position between the first avatar 381 and the second avatar may correspond to the relative position between the first tracking device 102 and the second tracking device 104.

In the scenario of FIG. 3G, the first tracking device 102 may, for example, display a second avatar 382 corresponding to the user 304 in the provided visual content 360 based on the means mentioned in the previous embodiment, but the disclosure is not limited thereto.

In summary, embodiments of the disclosure allow the first tracking device to provide relevant information for aligning each other's tracking information (such as reference relative pose, device information and coordinate conversion relationship) to the second tracking device by displaying the information pattern on the outward display. It can be seen from the above that the technical solution of the embodiment of the disclosure may align the tracking information between the first tracking device and the second tracking device in a more convenient and concise manner, thereby improving the user experience by avoiding lengthy operations in the prior art.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A tracking information alignment method, comprising:
displaying, by a first tracking device, an information pattern through an outward display, wherein the information pattern indicates device information of the first tracking device;
capturing, by a second tracking device, the information pattern, and accordingly determining a reference relative pose between the first tracking device and the second tracking device, and obtaining the device information of the first tracking device;
after the first tracking device and the second tracking device establish a connection based on the device information, sending, by the first tracking device, a first device pose of the first tracking device to the second tracking device through the connection, wherein the first device pose is characterized based on a first coordinate system used by the first tracking device; and
determining, by the second tracking device, a coordinate conversion relationship based on the reference relative pose and the received first device pose, and accordingly converting the received first device pose into a first reference device pose, wherein the first reference device pose is characterized based on a second coordinate system used by the second tracking device.

2. The method according to claim 1, wherein the first tracking device further comprises a near-eye display for displaying visual content of a provided reality service.

3. The method according to claim 1, further comprising:
displaying, by the second tracking device, visual content, wherein the visual content corresponds to a virtual world of a reality service;
rendering, by the second tracking device, a first avatar corresponding to the first tracking device based on the first reference device pose; and
displaying, by the second tracking device, the rendered first avatar in the visual content, wherein the virtual world comprises a second avatar corresponding to the second tracking device, and a first relative position between the first avatar and the second avatar corresponds to a second relative position between the first tracking device and the second tracking device.

4. The method according to claim 3, further comprising:
in response to receiving an updated first device pose from the first tracking device, accordingly updating, by the second tracking device, the first reference device pose; and
updating, by the second tracking device, a position of the first avatar in the virtual world based on the updated first reference device pose.

5. The method according to claim 1, wherein the device information of the first tracking device comprises identification information and supported connection protocols.

6. The method according to claim 1, wherein the information pattern further indicates display size information of the information pattern, and the method comprises:
capturing, by the second tracking device, an image comprising the information pattern through an outward camera, and determining a pattern size of the information pattern in the image;
determining, by the second tracking device, a reference relative pose between the first tracking device and the second tracking device based on a proportional relationship between the display size information of the information pattern and the pattern size of the information pattern in the image.

7. The method according to claim 1, wherein the information pattern is dynamically displayed.

8. The method according to claim 1, further comprising:
sending, by the first tracking device, the first device pose and identification information of the first tracking device concurrently to the second tracking device through the connection.

9. The method according to claim 1, further comprising:
displaying, by the second tracking device, an invitation confirmation message associated with the first tracking device in provided visual content based on the device information; and
in response to determining that the invitation confirmation message is triggered, establishing the connection between the second tracking device and the first tracking device.

10. The method according to claim 9, wherein the second tracking device maintains a server, and the method further comprises:
sending, by the second tracking device, an invitation message to the first tracking device through the connection, wherein the invitation message is used to invite the first tracking device to join the server;
displaying, by the first tracking device, the invitation message, and sending a confirmation message to the second tracking device when the invitation message is confirmed; and
adding, by the second tracking device, the first tracking device to the server in response to the confirmation message.

11. A tracking system, comprising:
a first tracking device, configured to display an information pattern through an outward display, wherein the information pattern indicates device information of the first tracking device; and
a second tracking device, configured to capture the information pattern, and accordingly determine a reference relative pose between the first tracking device and the second tracking device, and obtain the device information of the first tracking device, wherein
after the first tracking device and the second tracking device establish a connection based on the device information, the first tracking device sends a first device pose of the first tracking device to the second tracking device through the connection, wherein the first device pose is characterized based on a first coordinate system used by the first tracking device; and
the second tracking device determines a coordinate conversion relationship based on the reference relative pose and the received first device pose, and accordingly converts the received first device pose into a first reference device pose, wherein the first reference device pose is characterized based on a second coordinate system used by the second tracking device.

12. The tracking system according to claim 11, wherein the first tracking device further comprises a near-eye display for displaying visual content of a provided reality service.

13. The tracking system according to claim 11, wherein the second tracking device is further configured to perform:
displaying visual content, wherein the visual content corresponds to a virtual world of a reality service;
rendering a first avatar corresponding to the first tracking device based on the first reference device pose; and
displaying the rendered first avatar in the visual content, wherein the virtual world comprises a second avatar corresponding to the second tracking device, and a first relative position between the first avatar and the second avatar corresponds to a second relative position between the first tracking device and the second tracking device.

14. The tracking system according to claim 13, wherein the second tracking device is further configured to perform:
in response to receiving an updated first device pose from the first tracking device, accordingly updating the first reference device pose; and
updating a position of the first avatar in the virtual world based on the updated first reference device pose.

15. The tracking system according to claim 11, wherein the device information of the first tracking device comprises identification information and supported connection protocols.

16. The tracking system according to claim 11, wherein the information pattern further indicates display size information of the information pattern, and the second tracking device is configured to perform:
capturing an image comprising the information pattern through an outward camera, and determining a pattern size of the information pattern in the image;
determining the reference relative pose between the first tracking device and the second tracking device based on a proportional relationship between the display size information of the information pattern and the pattern size of the information pattern in the image.

17. The tracking system according to claim 11, wherein the first tracking device is further configured to send the first device pose and identification information of the first tracking device concurrently to the second tracking device through the connection.

18. The tracking system according to claim 11, wherein the second tracking device is further configured to perform:
displaying an invitation confirmation message associated with the first tracking device in provided visual content based on the device information; and
in response to determining that the invitation confirmation message is triggered, establishing the connection with the first tracking device.

19. The tracking system according to claim 18, wherein the second tracking device maintains a server, wherein
the second tracking device sends an invitation message to the first tracking device through the connection, wherein the invitation message is used to invite the first tracking device to join the server;
the first tracking device displays the invitation message and sends a confirmation message to the second tracking device when the invitation message is confirmed; and
the second tracking device adds the first tracking device to the server in response to the confirmation message.

20. A non-transitory computer-readable storage medium, wherein the non-transitory computer-readable storage medium records an executable computer program, and the executable computer program is loaded by a first tracking device and a second tracking device to perform the following steps:
displaying, by the first tracking device, an information pattern through an outward display, wherein the information pattern indicates device information of the first tracking device;
capturing, by the second tracking device, the information pattern, and accordingly determine a reference relative pose between the first tracking device and the second tracking device, and obtaining the device information of the first tracking device;
after the first tracking device and the second tracking device establish a connection based on the device information, sending, by the first tracking device, a first device pose of the first tracking device to the second tracking device through the connection, wherein the first device pose is characterized based on a first coordinate system used by the first tracking device; and
determining, by the second tracking device, a coordinate conversion relationship based on the reference relative pose and the received first device pose, and accordingly converting the received first device pose into a first reference device pose, wherein the first reference device pose is characterized based on a second coordinate system used by the second tracking device.
